(19) United States
(12) Patent Application Publication
(10) Pub. No.: US 2018/0291118 A1
(43) Pub. Date: Oct. 11, 2018

(54) METHOD FOR IMPROVING QUALITY AND REACTIVITY OF CELLULOSE

(71) Applicant: OBSHESTVO S OGRANICHENNOY OTVETSTVENNOSTYU "TWIN TECHNOLOGY COMPANY", MOSCOW (RU)

(72) Inventors: Yakov Kuzmich ABRAMOV, MOSCOW (RU); Vladimir Mihailovich VESELOV, MOSCOW (RU); Viktor Mihailovich ZALEVSKY, MOSCOW (RU); Vitaly Grigorievich TAMURKA, MOSCOW (RU); Veniamin Sergeevich VOLODIN, VIDNOYE (RU); Nikolay Aleksandrovich GUKASOV, MOSCOW (RU); Veniamin Sergeevich VOLODIN, (RU); Liudmila Mikhailovna MARSHANNIKOVA, MOSCOW (RU)

(73) Assignee: OBSHESTVO S OGRANICHENNOY OTVETSTVENNOSTYU "TWIN TECHNOLOGY COMPANY", MOSCOW (RU)

(21) Appl. No.: 15/763,459

(22) PCT Filed: Sep. 27, 2016
(86) PCT No.: PCT/RU2016/000644

§ 371 Date: Mar. 27, 2018

(30) Foreign Application Priority Data
Sep. 28, 2015 (RU) 2015141106

(51) Int. Cl. C08B 1/02

(52) U.S. Cl. CPC C08B 1/02

(57) ABSTRACT

The invention relates to the technology for the production of celluloses having improved properties and increased reactivity, and can be used in their chemical processing, including finished batches for the production of nitrocellulose and other products. A method for improving the quality and reactivity of cellulose comprises the following steps: impregnating and hydrolyzing the cellulose in a hydrolysis solution, filtering it from the hydrolysis solution, washing it with squeezing and drying. Moreover, the stages of impregnation and hydrolysis of cellulose in hydrolysis solution, filtration from hydrolysis solution, washing, squeezing and drying are carried out with simultaneous thermovacuum-impulse action by cycles, each of which includes the heating of cellulose to a temperature of not more than 115° C., high-speed impulse action of vacuum for time of less than 10 seconds, followed by exposure of the cellulose under vacuum and vacuum relief. The method allows improving the quality of cellulose, including its reactivity.

The invention relates to the production of celluloses having enhanced reactivity and quality, and can be used in their chemical processing, including finished batches for the production of nitrocellulose and other products.

Cellulose has a structure that consists of crystalline and amorphous parts. As a result, the absence of pre-treatment of cellulose, the replacement of the hydroxyl groups present in the crystalline parts, is difficult.

Thus, the need for additional activation of cellulose, including finished batches, is associated with a rather low content of their parameters, and in particular, the content of α-cellulose for wood, linen cellulose is 93-95%, while the content of lignin in cellulose finished batches reaches 2.5-4.5%. The content of α-cellulose in cotton cellulose from lint reaches 98%.

The quality of cellulose is determined by the properties of the raw materials and the technology for processing cellulose-containing raw materials into cellulose. Fluctuations in the technological parameters of the processes of pulping, bleaching, washing and instrumentation of processes affect the output characteristics of cellulose batches manufactured in factories.

Improving the cellulose output parameters is important not only to improve their quality, but also based on cellulose the nitrates of cellulose and, accordingly, gunpowders, varnishes, enamels and other materials.

Accordingly, the methods for activating (enhancing the reactivity) of cellulose using activating agents have been proposed. The purpose of these methods was to destroy the part of the crystalline areas to make them amorphous and accessible for substitute compounds.

Activating agents are generally used simultaneously with substitutional compounds and are the solutions of hydroxides such as hydroxides of metals (e.g., sodium hydroxide), ammonia, amines, dimethylformamides, dimethyl sulfoxides, and acetic acid. As the activating agent, sodium hydroxide is most often used.

To obtain significant activation, a significant amount of the activating agent is used. Therefore, in these processes, it is necessary to provide for the steps of removing the cellulose derivatives, which increases the cost of these methods

One of the methods for activating cellulose, intended for various types of processing, is the method for activating cellulose (inventor's certificate of USSR No. 335954 MIIK CO8B 1/00 with priority from 21 Jul. 1969), based on the treatment of cellulose with water, followed by displacement with a displacing reagent, for example acetic acid, at that, displacement of water is carried out under vacuum with vapor of a displacing reagent.

Activation of cellulose is achieved by filling with the agent causing the swelling of cellulose, ultramicroscopic spaces between the crystalline areas of cellulose and following displacement this agent with an organic solvent or its vapor. As a result of this processing, no compaction of the cellulose chains occurs, i.e. the cellulose active surface and its availability during subsequent chemical processing increase.

The main disadvantage of this method is the high consumption of the displacing reagent. Thus, when water is displaced from the swollen cellulose with acetic acid, at least a hundred times the amount of glacial acetic acid is required as per the weight of the cellulose.

There is also known a method for activating cellulose (inventor's certificate USSR No 952852 MIIK C08B 1/02 with priority from 19 Feb. 1981) by treatment with gaseous ammonia at room temperature under the pressure of 0.5-0.7 MPa for 1-2 hours, at which, to increase the efficiency of the process and the reactivity of cellulose, the cellulose is further treated with gaseous anhydride of carbonic, sulfuric or acetic acids under the pressure of 0.15-0.8 MPa for 3-15 minutes.

A disadvantage of this method is also a sufficiently high consumption of the displacing reagent, which leads to a rise in the cost of the process. In addition, the treatment of cellulose with carbonic acid, sulfuric acid or acetic anhydrides under increased pressure can create an explosive and fire hazard situation.

As a prototype, a method for producing reactive cellulose has been selected (RF patent No. 2202558 (n.5) MIIK C08B1/00, C08B1/02, C08B1/06 with priority from 9 Apr. 1998). The method includes the following steps: activating the cellulose by treatment with an activating agent, partially removing the activating agent until its residual weight content is below 10% by weight, introducing the activated cellulose obtained above into reaction with the organic compound or carbon disulfide, and possible removal of the activating agent residue and the by-products of the substitution reaction.

A disadvantage of this method of producing reactive cellulose is the use of additional chemical reagents that require subsequent removal and an increase in the duration of the process due to purification, as well as a deterioration in the quality of cellulose due to the incomplete removal of the organic compounds used.

The aim of the claimed invention is to improve the quality parameters of the cellulose produced, including characterizing its reactivity, while accelerating the activation process.

The object of the invention is achieved in that in the method for improving the quality and reactivity of cellulose by its activating, according to the invention, the activation of cellulose involves the following steps for affecting cellulose: impregnating and hydrolysis of cellulose in a hydrolysis solution, filtering the cellulose from the hydrolysis solution, washing, drying, at that, the steps of impregnating and hydrolysis the cellulose in a hydrolysis solution, filtration from hydrolysis solution, washing, squeezing and drying are performed with a simultaneous thermovacuum-pulse action by cycles, each of which involves heating the cellulose to a temperature of not more than 115° C., a high-speed impulse action of the vacuum within a pressure range of not more than 100 mm Hg for a time of less than 10 seconds, followed by exposure the cellulose to vacuum and vacuum relief.

Activation of the cellulosic material supplied from the pulp mill is carried out after its release from the wrapping material, followed by the separation of fibers in the hydrolysis solution during the impregnation and hydrolysis process.

If necessary, prior to the impregnation and hydrolysis of the cellulose in the hydrolysis solution, the pre-drying cellulose to a moisture content of not more than 12% is carried out.

High-speed impulse action of vacuum can be produced from a receiver with a high-speed valve. The receiver, in turn, must be connected to a vacuum source (vacuum pump).

The set goal is reached due to the fact that the stages of activation of cellulose (impregnation, hydrolysis, filtration, washing, filtration, and drying) are carried out using thermovacuum-impulse actions in the indicated modes. At impulse vacuuming of heated cellulose, the sorbed gases are removed from the surface of cellulose and its capillaries, and at the impregnating of cellulose with a hydrolysis solution, the wettability of cellulose increases and the degree of impregnation increases over the volume of the cellulose. This makes it possible also to impregnate the finished cellulose when it enters the plant after its release from the wrapping material. In addition, by means of the thermovacuum-impulse action, the moisture content of the material less than 12% is achieved, and the cellulose capillaries are not closed.

Thus, a such state of material is achieved, in which both a general weakening of the intermolecular interaction and a large internal surface with the presence of the finest capillaries that promote greater accessibility for the subsequent technological process take place.

Correspondingly, with the hydrolysis solution under intense boiling in vacuum, more complete dissolution of lignin, pectin, resins and other compounds contained in cellulose, in which the content of α-cellulose increases, thereby releasing the ultramicroscopic spaces between the crystalline areas and increasing its reactivity is achieved.

In addition, the exclusion of processes for purification of cellulose against additional organic compounds and vacuum-impulse action accelerate the activation process.

The proposed method for activating cellulose can be implemented either in the pulp mill at the end of the process or before the subsequent use of the finished cellulose.

The method of activation of the finished cellulose is carried out as follows.

After unpacking, finished cellulosic material is placed in a cooker (hydrolyzer) and subjected to successive processing steps: drying to a moisture content of not more than 12% (if necessary), impregnation and hydrolysis in a hydrolysis solution, filtration of cellulose from the hydrolysis solution, washing of cellulose after hydrolysis, and subsequent pressing and drying. Moreover, these technological processes of impregnation and hydrolysis of cellulose in hydrolysis solution, filtration of cellulose from hydrolysis solution, washing after hydrolysis, squeezing and drying are carried out with simultaneous application of thermovacuum-impulse actions by cycles including the heating of cellulose to a temperature of not more than 115° C., high-speed impulse vacuuming the cooker with the cellulose in it, for a time of less than 10 seconds to a pressure of not more than 100 mm Hg; with exposure and degassing of cellulose under vacuum for 1-3 minutes, then a vacuum is discharged in the apparatus containing the cellulose by a heat air medium heated to 100-150° C.

The high-speed impulse action of vacuum is carried out from a vacuum source—a vacuum receiver through a high-speed valve. A vacuum pump connected to the receiver provides vacuum.

Examples of quality and reactivity control of finished cellulose after activation by the claimed method:

To improve the quality of finished batches of celluloses manufactured at the appropriate plants, improving their quality and reactivity with the use of hydrolysis solutions in the thermovacuum-impulse mode, celluloses were taken from the finished batches of cellulose: cotton (CC), wood (WC), sheet cellulose (SC) of CA-grade, and flax sheet cellulose (FSC).

Technical parameters of celluloses of finished batches before and after activation by the claimed method are given in the table.

| | | WC | | | WC | |
|---|---|---|---|---|---|---|
| | | sulphate | | | sulphate | |
| | CC | CA - grade | FSC | CC | CA -grade | FSC |
| Parameters | parameters before activation | | | parameters after activation | | |
| Content | 96.0-97.2 | 95.6-96.5 | 92.8-95.7 | 97.5-98.7-99.1 | 96.8-98.6 | 94.5-97.7 |
| α-cellulose, %, not | | | | | | |
| less than | | | | | | |
| Wettability, g, not | 130-135 | 130-135 | 105-130 | 147-150 | 135-138 | 135-140 |
| less than | | | | | | |
| Viscosity, mPa s | 20-30 | 20-21 | 21-25 | 7.0-8.3 | 5.6-7.4 | 8.0-10.0 |
| Lignin content, %, | — | 0.3-0.4 | 0.1-0.38 | — | 0.1 | — |
| not more than | | | | | | |
| Resin and fats | — | 0.07-0.5 | 0.2-0.4 | — | 0.1 | 0.1 |
| content, %, not | | | | | | |
| more than | | | | | | |
| Dust content, %, | 2.0 | 7.0 | 2.0 | 0.4 | 1.2 | 0.3 |
| not more than | | | | | | |
| Ash content, %, | 0.1-0.2 | 0.15-0.3 | 0.1-0.3 | 0.01 | 0.1 | 0.15 |
| not more than | | | | | | |
| Humidity, %, not | 10 | 7-12 | 10 | 5.0 | 6.0 | 8.0 |
| more than | | | | | | |
| Degree of | 2500-3500 | 3300-4300 | 1000-1400 | 280 | 420 | 320 |
| polymerization | | | | | | |

From the data given, it follows that the treatment of finished batches of celluloses with the claimed method significantly improves the technical parameters of celluloses.

1. A method for improving quality and reactivity of a cellulose by its activating wherein an activation of the cellulose involves the following steps to affect the cellulose:
impregnating and hydrolysis of the cellulose in a hydrolysis solution,
filtering the cellulose from the hydrolysis solution,
washing, squeezing and drying at that the steps of impregnating and hydrolysis of the cellulose in the hydrolysis solution,
filtration from hydrolysis solution, washing, squeezing and drying are performed with a simultaneous thermovacuum-pulse action by cycles, each of which involves
heating the cellulose to the temperature of not more than 115° C., a high-speed impulse action of vacuum within a pressure range of not more than 100 mm Hg for a time of less than 10 seconds, followed by exposure the cellulose to vacuum and vacuum relief.

2. The method of claim 1, wherein the impregnation of a celluloses material supplied from a pulp mill is carried out after its clearing from a wrapping material, followed by the separation of fibers in the hydrolysis solution during the impregnation and hydrolysis of the cellulose.

3. The method of claim 1, wherein prior to impregnation and hydrolysis of the cellulose in the hydrolysis solution, it is pre-dried to a moisture content of not more than 12%.

4. The method of claim 1, wherein high-speed impulse action of vacuum is produced from a receiver with a high-speed valve.
